(19) United States
(12) Patent Application Publication
(10) Pub. No.: US 2021/0197851 A1
(43) Pub. Date: Jul. 1, 2021

(54) METHOD FOR BUILDING VIRTUAL SCENARIO LIBRARY FOR AUTONOMOUS VEHICLE

(71) Applicants: YANSHAN UNIVERSITY, QINHUANGDAO (CN); JILIN UNIVERSITY, CHANGCHUN (CN)

(72) Inventors: LISHENG JIN, QINHUANGDAO (CN); DONGXIAN SUN, QINHUANGDAO (CN); BAICANG GUO, QINHUANGDAO (CN); YUHAN WANG, QINHUANGDAO (CN); JIAN SHI, QINHUANGDAO (CN); FUGANG YAN, QINHUANGDAO (CN); FA SI, QINHUANGDAO (CN); MING GAO, QINHUANGDAO (CN); QIANG HUA, QINHUANGDAO (CN); YI ZHENG, QINHUANGDAO (CN); SHUNRAN ZHANG, QINHUANGDAO (CN); SUHUA JIA, QINHUANGDAO (CN); HAOTIAN CHI, QINHUANGDAO (CN)

(21) Appl. No.: 16/998,478

(22) Filed: Aug. 20, 2020

(30) Foreign Application Priority Data
Dec. 30, 2019 (CN) 201911392624.1

(51) Int. Cl. B60W 60/00; G06K 9/62; G06K 9/00; B60W 40/04

(52) U.S. Cl. CPC B60W 60/001; G06K 9/6223; G06K 9/00711; B60W 2554/40; B60W 40/04; B60W 2554/20; G06K 9/00791

(57) ABSTRACT

The present invention relates to a method for building a virtual scenario library for autonomous vehicles, including steps such as acquiring data, extracting data, cleaning data, annotating scenario elements, forming a data set, determining an optimal k value, determining initial clustering centers, obtaining logical scenarios, and building a virtual scenario library. The present invention provides a theoretical basis and technical support for the building of a virtual scenario library for autonomous driving. The method is easy to operate, and can provide a large number of test target scenario environments meeting different requirements, to test the safety of an autonomous driving system in virtual scenarios. Compared with vehicle test in real environments, this method is more cost-effective, efficient, and repeatable, and can simulate a variety of different scenarios, to speed up the research and development of autonomous vehicles and promote the safe deployment of autonomous vehicles.

### TECHNICAL FIELD

The present invention relates to the field of virtual simulation testing of autonomous vehicles, and in particular, to a method for building a virtual scenario library for autonomous vehicles.

### BACKGROUND

In recent years, more and more traditional car companies and emerging technology companies are engaged in the research and development of autonomous vehicles, and some of them have begun to test the autonomous vehicles on the road. According to RAND's research report, to prove the safety of autonomous vehicles, road testing of about 5 billion miles are required, that is, it takes about 225 years for a fleet of 100 vehicles keeping driving 24/7/365 at an average speed of 25 miles per hour to complete the tests.

Therefore, innovative validation and evaluation methods are required to accelerate the safe deployment of autonomous vehicles. The scenario-based virtual simulation test for autonomous vehicles is cost-effective, efficient, and repeatable, and has a large number of test scenarios. It is an important method for autonomous vehicle testing in the future. However, the scenario-based virtual simulation testing industry for autonomous vehicles is still in its infancy, without much systematic theoretical research and support for building virtual scenario libraries.

### SUMMARY

In order to solve the above technical problems, the present invention provides a method for building a virtual scenario library for autonomous vehicles. In this method, logical scenario data is obtained based on the statistics of naturalistic driving data through clustering of unsupervised learning, and a virtual scenario library is built in PreScan software. The method includes the following steps:

Step 1: Set up a data acquisition system on a data acquisition vehicle, where the system includes a video data acquisition module, a vehicle motion parameter acquisition module, a surrounding environment information acquisition module, and a data storage module; and the video data acquisition module, the vehicle motion parameter acquisition module, and the surrounding environment information acquisition module are connected to the data storage module, to store acquired naturalistic driving data in the data storage module;

the video data acquisition module is a monocular camera, and configured to acquire forward driving scenario video data during driving; the vehicle motion parameter acquisition module is a CAN bus analyzer, and configured to acquire vehicle motion parameter data during driving; and the surrounding environment information acquisition module is a millimeter wave radar, and configured to acquire surrounding environment information data during driving.

Step 2: Determine a target scenario, manually select video data of the target scenario from the data storage module, and extract vehicle motion parameter data acquired by the CAN bus and surrounding environment information data acquired by the millimeter wave radar within a corresponding time period.

Step 3: Perform data cleaning on the selected target scenario data, including removing redundant data, deleting incomplete data, and recovering data.

The cost of the data cleaning should be minimized on the premise of ensuring the data quality. The data recovery includes manual completion of key information and statistical rule-based data recovery. The cleaning cost is as follows:

$${C}_{ost} ( t ) = ω ( t ) {\sum }_{A ∈ R} {D}_{istance} ( {t}_{A} , {t}_{A}^{′} )$$

$${C}_{ost} ( l ) = {\sum }_{t ∈ l} {C}_{ost} ( t )$$

In the formula, t is a single data tuple; ω(t) is a proportion of the data tuple t in all data tuples; I is the sum of all data tuples; and D_{istance} (t_{A}, t′_{A}) is a distance between an element t_{A} and the recovered t′_{A}.

Step 4: Annotate scenario elements and classify the scenario elements into ego vehicle information, traffic participant information, road environment information, and natural environment information, where the ego vehicle information includes one or more of ego vehicle basic information, ego vehicle target information, and ego vehicle driving behavior; the traffic participant information includes one or more of pedestrian information, non-motor vehicle information, and motor vehicle information; the road environment information includes one or more of static road information and dynamic road information; and the natural environment information includes one or more of illumination and weather;

encode and quantify continuous variables and classified variables in the scenario elements, where for the continuous variables, a minimum value is set to 0, a maximum value is set to 1, and the remaining values are proportionally mapped in the range of 0 to 1; for example, for quantification of a relative distance of a vehicle, a minimum value is set to 0, a maximum value is set to 1, and the remaining values are proportionally mapped in the range of 0 to 1; and for the classified variables, a value range is quantified as 0 and 1; for example, for cut-in directions in a cut-in scenario, left cut-in is set to 0, and right cut-in is set to 1;

import quantified values of scenario elements into a txt file, to form a target scenario data set, where a row represents the number of target scenario samples, and each value in the row represents specific scenario element information.

Step 5: Use the k-means clustering algorithm for initial clustering, to set the k value to 2, 3, 4, 5, 6, 7, 8, and 9 in turn and calculate a sum of square errors (SSE) based on clustering results under different k values, where an SSE calculation formula is:

$$SSE = {\sum }_{i = 1}^{k} {\sum }_{P ∈ {C}_{i}} \vert P - {m}_{i} {\vert}^{2}$$

where Cᵢ is the i-th cluster; P is a sample point of Cᵢ; and mᵢ is an average value of all samples in Cᵢ, that is, the centroid;

determine the true number of clusters of the data, that is, an optimal k value, based on a relationship between the SSEs and the k values. The relationship between the SSEs and the k values is as follows: As the number k of clusters increases, samples are classified in a more refined manner, an aggregation degree of each cluster gradually increases, and the SSE gradually decreases. In addition, when k is less than the true number of clusters, the SSE decreases dramatically because the increase of the k value greatly increases the aggregation degree of each cluster; when the k value reaches the true number of clusters, increasing the k value causes the SSE to decrease slowly, which means the k value corresponding to the inflection point of the correlation curve between the SSEs and the k values is the true number of clusters, that is, the optimal k value.

Step 6: Use the hierarchical clustering algorithm to cluster the target scenario data until k clusters are obtained; and use the group-average method to calculate a distance between the clusters, where k is the optimal k value determined in step 5, and a clustering calculation formula is:

$${D}_{pq} = \frac{1}{{n}_{p} {n}_{q}} {\sum }_{{x}_{i} ∈ {G}_{p}} {\sum }_{{x}_{j} ∈ {G}_{q}} {d}_{ij}$$

Gₚ and G_{q} are the p-th cluster and the q-th cluster; nₚ and n_{q} are the numbers of samples in clusters Gₚ and G_{q}; dᵢⱼ is a distance between samples xᵢ and xⱼ; and D_{pq} is an average distance between clusters;

select data closest to the center from each cluster to obtain k clustering centers.

Step 7: Use the k-means clustering algorithm again for clustering, where k is the optimal k value obtained in step 5; by taking the k clustering centers determined in step 6 as the initial centers, cluster the target scenario data through the k-means clustering algorithm to obtain k abstract target scenario clusters, that is, k logical scenarios.

Step 8: Determine salient scenario elements and their data values based on the k logical scenarios obtained by clustering, and then use a scenario element module in the virtual simulation test software PreScan to build k virtual scenarios to form a virtual scenario library for the target scenario.

Use PreScan with MATLAB/Simulink for co-simulation, to validate and evaluate the performance and safety of an autonomous driving system in each target scenario library.

### Advantageous Effects of Invention

Based on the acquisition of naturalistic driving data and cluster analysis, the present invention proposes a method for building a virtual scenario library for virtual simulation testing of autonomous vehicles, providing a theoretical basis and technical support for the building of a virtual scenario library for autonomous driving. This method is easy to operate, and can provide a large number of test target scenario environments meeting different requirements, to test the safety of the autonomous driving system in virtual scenarios. Compared with vehicle test in real environments, this method is more cost-effective, efficient, and repeatable, and can simulate a variety of different scenarios, to speed up the research and development of autonomous vehicles and promote the safe deployment of autonomous vehicles.

### BRIEF DESCRIPTION OF DRAWINGS

FIG. 1 is a flowchart of a method for building a virtual scenario library for autonomous vehicles according to an example of the present invention.

FIG. 2 is a schematic diagram of scenario elements according to an example of the present invention.

### REFERENCE NUMERALS

S1: Set up a naturalistic driving data acquisition system and acquire data
S2: Extract cut-in scenario data from the acquired natural driving data
S3: Perform data cleaning
S4: Annotate scenario library elements and form a cut-in scenario data set
S5: Determine an optimal k value based on a relationship between SSEs and k values
S6: Determine an optimal k value based on a relationship between SSEs and k values
S7: Use the k-means clustering method to obtain k cut-in logical scenarios
S8: Use PreScan to build a virtual scenario library for the cut-in scenario
1. Scenario element
2. Ego vehicle information
3. Traffic participant information
4. Road environment information
5. Natural environment information
6. Ego vehicle basic element
7. Ego vehicle target information
8. Ego vehicle driving behavior
9. Pedestrian information
10. Non-motor vehicle information
11. Motor vehicle information
12. Static road information
13. Dynamic road information
14. Illumination
15. Weather

### DETAILED DESCRIPTION

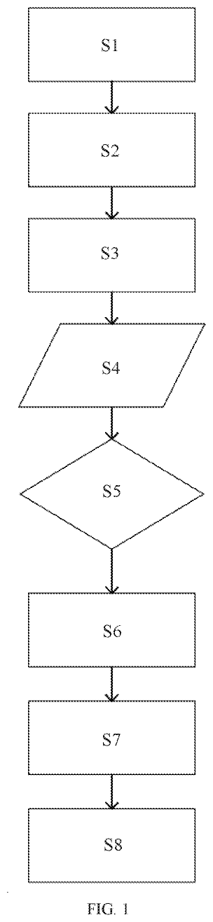

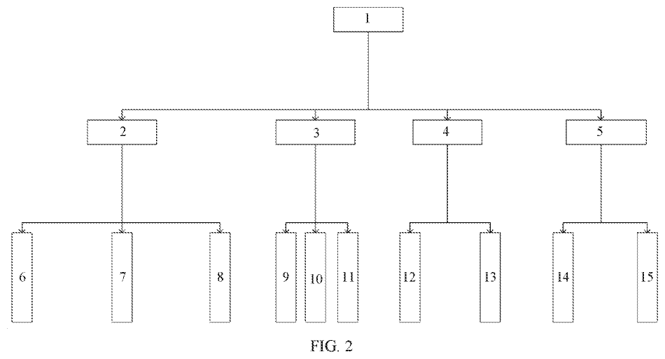

As shown in FIG. 1 and FIG. 2, this example uses the method of the present invention to build a virtual scenario library for cut-in of an autonomous vehicle. The specific steps are as follows:

Step 1: Install a monocular camera, a CAN bus analyzer, and a millimeter wave radar on a vehicle to acquire naturalistic driving data during driving, where the monocular camera is configured to acquire forward driving scenario video data; the CAN bus analyzer is configured to acquire vehicle motion parameter data, and the millimeter wave radar is configured to acquire data such as a relative speed and a relative distance; and store the data in a data storage module.

Step 2: In this example, define a cut-in scenario as a process that starts from a steering behavior of a front cut-in vehicle and ends when a centroid position of the cut-in vehicle is at a center axis of a lane where a ego vehicle is located; after the naturalistic driving data acquisition is complete, filter data based on the scenario definition. Specifically, manually capture video data of the cut-in scenario, and extract the data acquired by the CAN bus and the millimeter wave radar within a corresponding time period to form the naturalistic driving data of the cut-in scenario.

Step 3: Perform data cleaning on the selected target scenario data, including removing redundant data, deleting incomplete data, and recovering data.

The cost of the data cleaning should be minimized on the premise of ensuring the data quality. The data recovery includes manual completion of key information and statistical rule-based data recovery. The cleaning cost is as follows:

$${C}_{ost} ( t ) = ù ( t ) {\sum }_{A ∈ R} {D}_{istance} ( {t}_{A} , {t}_{A}^{′} )$$

$${C}_{ost} ( l ) = {\sum }_{t ∈ l} {C}_{ost} ( t )$$

In the formula, t is a single data tuple; ù(t) is a proportion of the data tuple t in all data tuples; I is the sum of all data tuples; and D_{istance} (t_{A}, t′_{A}) is a distance between an element t_{A} and the recovered t′_{A}.

Step 4: Annotate scenario elements. In the cut-in scenario, the scenario elements include ego vehicle information, cut-in vehicle information, and natural environment information, where the ego vehicle information includes ego vehicle basic elements, where the ego vehicle basic elements include a ego vehicle speed, a relative speed, a relative distance, and a time headway; the cut-in vehicle information includes a cut-in vehicle type and a cut-in direction, where the vehicle types include sedan, SUV, MPV, bus, and truck, and the cut-in directions include left cut-in and right cut-in; and the natural environment information includes illumination and weather, where the illumination includes daytime and night, and the weather includes rain, snow, fog, and so on.

Encode and quantify continuous variables and classified variables in the scenario elements, and then proportionally map values to the range of 0 to 1, to form a corresponding target scenario data set, as shown in Table 1. A calculation formula for the time headway is as follows:

$${T}_{hw} = \frac{D}{{V}_{s}}$$

T_{hw} is the time headway; D is a relative distance between the ego vehicle and the cut-in vehicle; and Vₛ is a speed of the ego vehicle.

TABLE 1
Scenario element quantification reference table

| Scenario | | | |
|---|---|---|---|
| Element Type | Scenario Element Name | Value | Code |
| Continuous | Ego vehicle speed | Minimum value | 0 |
| variable | | Maximum value | 1 |
| | Relative distance | Minimum value | 0 |
| | | Maximum value | 1 |
| | Relative speed | Minimum value | 0 |
| | | Maximum value | 1 |
| | Time headway | Minimum value | 0 |
| | | Maximum value | 1 |
| Classified | Cut-in vehicle type | Sedan | 0 |
| variable | | SUV and MPV | 0.5 |
| | | Bus and truck | 1 |
| | Illumination | Daytime | 0 |
| | | Night | 1 |
| | Weather | Sunny | 0 |
| | | Rain | 0.25 |
| | | Snow | 0.5 |
| | | Fog | 0.75 |
| | | Sand and dust | 1 |

Step 5: Set the k value to 2, 3, 4, 5, 6, 7, 8, and 9 in turn, and use the k-means clustering algorithm to cluster each k value, calculate a sum of square errors (SSE), and determine an optimal k value based on a relationship between the SSEs and the k values. As the number k of clusters increases, samples are classified in a more refined manner, an aggregation degree of each cluster gradually increases, and the SSE gradually decreases. When k is less than the true number of clusters, the SSE decreases dramatically because the increase of the k value greatly increases the aggregation degree of each cluster; when the k value reaches the true number of clusters, increasing the k value will cause the aggregation degree to decrease greatly and the SSE to decrease slowly. Therefore, the correlation curve between the SSEs and the k values is similar to the elbow shape, and the k value corresponding to the inflection point of the curve is the true number of clusters, that is, the optimal k value. An SSE calculation formula is as follows:

$$SSE = {\sum }_{i = 1}^{k} {\sum }_{P ∈ {C}_{i}} \vert P - {m}_{i} {\vert}^{2}$$

Cᵢ is the i-th cluster; P is a sample point of Cᵢ; and mᵢ is an average value of all samples in Cᵢ, that is, the centroid.

Step 6: For the k-means clustering algorithm, the k value and initial centers must be properly selected. Therefore, after the optimal k value is determined, obtain k initial centers. Use the hierarchical clustering algorithm to cluster the target scenario data and determine the initial centers. Use the group-average method to calculate a distance between clusters, and stop when the hierarchical clustering algorithm divides data into k clusters, and then select data closest to the center from each cluster as the initial center of the k-means clustering algorithm. A clustering calculation formula used in the group-average method is as follows:

$${D}_{pq} = \frac{1}{{n}_{p} {n}_{q}} {\sum }_{{x}_{i} ∈ {G}_{p}} {\sum }_{{x}_{j} ∈ {G}_{q}} {d}_{ij}$$

Gₚ and G_{q} are the p-th cluster and the q-th cluster; nₚ and n_{q} are the numbers of samples in clusters Gₚ and G_{q}; dᵢⱼ is a distance between samples xᵢ and xⱼ; and D_{pq} is an average distance between clusters.

Step 7: Use the k-means clustering algorithm to cluster a cut-in scenario data set based on the optimal k value obtained in step 5 and the k initial centers determined in step 6, to obtain k abstract cut-in scenario clusters, that is, k cut-in logical scenarios.

Step 8: Determine salient scenario elements and their data values based on the k logical scenarios obtained by clustering, and then use a scenario element module in the virtual simulation test software PreScan to build k virtual scenarios to form a virtual scenario library for the cut-in scenario.

Use PreScan with MATLAB/Simulink for co-simulation, to validate and evaluate the performance and safety of an autonomous driving system in the virtual scenario library for the cut-in scenario.

What is claimed is:

1. A method for building a virtual scenario library for autonomous vehicles, comprising:
step 1: setting up a data acquisition system on a data acquisition vehicle, wherein the system comprises a video data acquisition module, a vehicle motion parameter acquisition module, a surrounding environment information acquisition module, and a data storage module; and the video data acquisition module, the vehicle motion parameter acquisition module, and the surrounding environment information acquisition module are connected to the data storage module, to store acquired naturalistic driving data in the data storage module;
step 2: determining a target scenario, selecting video data of the target scenario from the data storage module, and extracting vehicle motion parameter data and surrounding environment information data acquired within a corresponding time period;
step 3: performing data cleaning on the selected target scenario data, comprising removing redundant data, deleting incomplete data, and recovering data;
step 4: annotating scenario elements, classifying the scenario elements, and encoding and quantifying specific parameters in each scenario element, to form a target scenario data set;
step 5: using the k-means clustering algorithm for initial clustering; calculating a sum of square errors (SSE) based on clustering results under different k values, and determining the true number of clusters, that is, the optimal k value, based on a correlation curve between the SSEs and the k values;
step 6: using the hierarchical clustering algorithm to cluster the target scenario data until k clusters are obtained; and selecting data closest to the center from each cluster to obtain k cluster centers, wherein k is the optimal k value determined in step 5;
step 7: using the k-means clustering algorithm to cluster the target scenario data, to obtain k abstract target scenario clusters, that is, k logical scenarios, wherein k is the optimal k value obtained in step 5, and the initial centers are the k clustering centers determined in step 6; and
step 8: determining salient scenario elements and their data values based on the k logical scenarios obtained by clustering, and then using the virtual simulation test software to build k virtual scenarios to form a virtual scenario library for the target scenario.

2. The method for building a virtual scenario library for autonomous vehicles according to claim 1, wherein in step 1, the video data acquisition module is a monocular camera; the vehicle motion parameter acquisition module is a CAN bus analyzer; and the surrounding environment information acquisition module is a millimeter wave radar.

3. The method for building a virtual scenario library for autonomous vehicles according to claim 1, wherein in step 3, the cost of the data cleaning is minimized on the premise of ensuring the data quality; the data recovery comprises manual completion of key information and statistical rule-based data recovery; and the cleaning cost is:
$${C}_{ost} ( t ) = ù ( t ) {\sum }_{A ∈ R} {D}_{istance} ( {t}_{A} , {t}_{A}^{′} )$$
$${C}_{ost} ( l ) = {\sum }_{t ∈ l} {C}_{ost} ( t )$$
wherein t is a single data tuple; ù(t) is a proportion of the data tuple t in all data tuples; I is the sum of all data tuples; and D_{istance} (t_{A}, t′_{A}) is a distance between an element t_{A} and the recovered t′_{A}.

4. The method for building a virtual scenario library for autonomous vehicles according to claim 1, wherein in step 4 of annotating scenario elements, the scenario elements are classified into ego vehicle information, traffic participant information, road environment information, and natural environment information, wherein the ego vehicle information comprises one or more of ego vehicle basic information, ego vehicle target information, and ego vehicle driving behavior; the traffic participant information comprises one or more of pedestrian information, non-motor vehicle information, and motor vehicle information; the road environment information comprises one or more of static road information and dynamic road information; and the natural environment information comprises one or more of illumination and weather.

5. The method for building a virtual scenario library for autonomous vehicles according to claim 4, wherein continuous variables and classified variables in each scenario element are encoded and quantified; for the continuous variables, a minimum value is set to 0, a maximum value is set to 1, and the remaining values are proportionally mapped in the range of 0 to 1; and values of the classified variables are quantified as 0 and 1; the quantified values of the specific scenario elements are imported into a file to form a target scenario data set, wherein a row represents the number of target scenario samples, and each value in the row represents specific scenario element information.

6. The method for building a virtual scenario library for autonomous vehicles according to claim 1, wherein in step 5, the k value is set to 2, 3, 4, 5, 6, 7, 8, and 9 in turn, and the k-means clustering algorithm is used for initial clustering, wherein an SSE calculation formula is:
$$SSE = {\sum }_{i = 1}^{k} {\sum }_{P ∈ {C}_{i}} \vert P - {m}_{i} {\vert}^{2}$$
wherein C₁ is the i-th cluster; P is a sample point of Cᵢ; and mᵢ is an average value of all samples in Cᵢ, that is, the centroid; and the relationship between the SSEs and the k values is as follows: as the number k of clusters increases, the SSE gradually decreases; when k is less than the true number of clusters, the SSE decreases dramatically; when the k value reaches the true number of clusters, increasing the k value causes the SSE to decrease slowly, which means the k value corresponding to the inflection point of the correlation curve between the SSEs and the k values is the true number of clusters, that is, the optimal k value.

7. The method for building a virtual scenario library for autonomous vehicles according to claim 1, wherein in step 6 of using the hierarchical clustering algorithm to cluster the target scenario data, a distance between clusters is calculated by using the group-average method, wherein a clustering calculation formula is:
$${D}_{pq} = \frac{1}{{n}_{p} {n}_{q}} {\sum }_{{x}_{i} ∈ {G}_{p}} {\sum }_{{x}_{j} ∈ {G}_{q}} {d}_{ij}$$
wherein Gₚ and G_{q} are the p-th cluster and the q-th cluster; nₚ and n_{q} are the numbers of samples in clusters Gₚ and G_{q}; dᵢⱼ is a distance between samples xᵢ and xⱼ; and D_{pq} is an average distance between clusters.

8. The method for building a virtual scenario library for autonomous vehicles according to claim 1, wherein in step 8, a scenario element module in the virtual simulation test software PreScan is used to build a virtual scenario.
